(19) United States
(12) Patent Application Publication
(10) Pub. No.: US 2003/0208379 A1
(43) Pub. Date: Nov. 6, 2003

(54) Claims clinical code editing and procedure management tool

(76) Inventors: Robert S. Haskey, Seattle, WA (US); Ted R. Mayhugh, Tigard, OR (US); Dale K. Rasmussen, Fruit Heights, UT (US); Sheryl D Turner, Forest Grove, OR (US); Diane P. Kenyon, S.E. Turner, OR (US); Becky L. Bann, Lewiston, ID (US); Patricia A. Schulz, West Linn, OR (US); Bonita K. Bogen, Port Angeles, WA (US); Hope C. Aguila, Renton, WA (US); John Rusche, Lewiston, ID (US); Gina G. Quesenberry, Lewiston, ID (US); Marcia J. Panattoni, Boise, ID (US)

Correspondence Address: BLACK LOWE & GRAHAM PLLC, 816 Second Avenue, Seattle, WA, 98104, US

(21) Appl. No.: 10/372,026

(22) Filed: Feb. 21, 2003

Related U.S. Application Data
(60) Provisional application No. 60/358,768, filed on Feb. 22, 2002.
(60) Provisional application No. 60/380,407, filed on May 13, 2002.

(51) Int. Cl. G06F 17/60

(52) U.S. Cl. 705/2

(57) ABSTRACT

A system, method, and user interface for performing maintenance of procedure clinical edit data and associated clinical code editing rules. The system includes a health insurance company and at least one health care provider. The health insurance company includes a computer system with a graphical user interface tool for generating a plurality of health care procedure clinical code editing rules and clinical edit data, and a component for sending at least a portion of the generated plurality of health care procedure clinical code editing rules to a recipient over a data network. The health care provider includes a computer system coupled to the data network for receiving the sent plurality of health care procedure clinical code editing rules and for presenting the received plurality of clinical code editing rules for review. The health care provider also includes a means for entering a claim for one or more performed health care procedures based on review of the plurality of clinical code editing rules.

### FIELD OF THE INVENTION

This invention relates generally to health care and, more specifically, to medical billing/reimbursement practices.

### BACKGROUND OF THE INVENTION

As is commonly known, many people purchase insurance in order to spread the risk of financial liability resulting from the occurrence of an event covered by the insurance policy. For example, it is very common for a person to carry medical insurance coverage, such that some or all expenses associated with the treatment of medical conditions experienced by that person will be borne by the insurance company. Such insurance coverage may be offered by insurance companies because, while benefits paid by the insurance company for some of the insureds will greatly exceed the amounts paid by these insureds for their policies, the majority of the insureds will pay more for their policies than they will receive in benefits from the insurance company. In this way, the total group of insureds is spreading the risk for liability for the entire group's medical costs.

Whenever an insured desires to receive payment from the insurance company to cover some or all of the cost of a medical treatment, the insured, or more typically the provider of the medical treatment services on behalf of the insured, is required to submit a claim to the insurance company. This claim is then evaluated by the insurance company, which then makes a determination as to whether the insurance company will provide a payment and, if so, how much of the total charge for the medical treatment the insurance company will pay for. For example, many insurance policies include deductibles which must be met by the insured before the insurance company begins to assume financial liability for medical treatment. Such deductibles can be on a per visit basis, a yearly basis, etc. After the deductible has been met by the particular insured, many policies still do not pay the total remaining charge for the medical treatment, but instead may provide payments on a cost-sharing basis with the insured. Other factors which may have a bearing upon the amount paid by the insurance company include per-occurrence maximums and lifetime maximums, both of which will cap the total liability of the insurance company. Contractual relationships developed between the insurance company and a network of healthcare providers who are accessed by the insured will also effect the total liability of the insurance company. Because of these factors, claims submitted to an insurance company must go through a process known as claim adjudication. In the claim adjudication process, the insurance company evaluates all the claim data submitted by the insured or healthcare service provider and makes a determination as to what benefits the insurance company will pay on behalf of the insured for the healthcare services rendered by the provider to the insured. The results of the claim adjudication process are typically communicated to the insured by means of a printed explanation of benefits (EOB) statement. Likewise, the results of the claim adjudication process are also communicated to the healthcare service provider by means of a printed voucher or similar document.

Various types of coding systems have thus evolved as a type of language to communicate in a nationally accepted common format that is readable by electronic claims payment systems. For billing purposes, the use of the International Classifications of Diseases (ICD) codes, when juxtaposed to Current Procedural Terminology (CPT) codes and Health Care Procedure Coding System (HCPCS) codes, tells the payer not only what service has been provided but also lists the diagnosis, symptom, complaint, condition or problem (e.g., the reason for performing the service), as well as resources used. The codes thus help establish the medical necessity as the first step in third party reimbursement.

The coder, the professional service provider or assignee thereof, must determine the code to be used following each patient encounter. Coding is done by a variety of people who possess a wide range of skill and expertise in the accomplishment of this complex task of translation of a clinical service to a numerical equivalent. There is a chronic shortage of top-notch professionally certified coders and code profile consultants. As a result of these and other conditions there are numerous errors in the billing process that result in inappropriate reimbursement. This condition adds further financial stress in both the government as well as private sector of the healthcare industry through the waste of funds, time and human resources. Further compounding the situation is the fact that the person submitting the encoded translation of a clinical service to a numerical equivalent may have little or no idea of the rule set being applied to the adjudication of the code(s) being submitted. As a result, claims are rejected, or not paid in full, but those who submit the claims often will not have a clear or precise idea as to why. This leads to frustration, mistrust, inefficiency, and ultimately higher health care costs. Thus, there exists a need to allow all users of the language of medical coding an opportunity to understand the applicable rules in this complex system.

### SUMMARY OF THE INVENTION

A system, method, and user interface for performing maintenance of procedure clinical coding edit data and associated clinical coding rules are provided. The system includes a health insurance company and at least one health care provider. The health insurance company includes a computer system with a graphical user interface tool for generating a plurality of health care procedure clinical coding rules and clinical edit data, and a component for sending at least a portion of the generated plurality of health care procedure clinical coding rules to a recipient over a data network. The health care provider includes a computer system coupled to the data network for receiving the sent plurality of health care procedure clinical coding rules and for presenting the received plurality of clinical coding rules for review. The health care provider also includes a means for entering a claim for one or more performed health care procedures based on review of the plurality of clinical coding rules.

The health care provider further includes a component for sending the entered claim to the health insurance company. The health insurance company processes the sent claim according to the health care procedure clinical coding rules, and generates remittance based on the processed claim.

The clinical coding rules are optionally and preferably based on Current Procedural Terminology (CPT), Correct Coding Initiative (CCI), and administrative rules as found in the Federal Register.

The clinical coding rules are optionally and preferably further based on CPT Assistant from the American Medical Association, and Medicode's Coders Desk Reference Manual and Coders Desk Reference for Pathology and Laboratory.

The computer system of the health insurance company optionally and preferably further includes a graphical user interface tool for editing the clinical coding rules.

A computer generated graphical user interface (gui) for managing clinical edit data and clinical code editing rules for medical procedures of a medical claims processing applications program is optionally and preferably provided. The gui includes a presentation component configured to present at least a portion of the medical procedures and associated clinical edit data, and a clinical coding rules presentation component configured to present the clinical coding rules associated with the medical procedures.

As will be readily appreciated from the foregoing summary, the invention provides a system and method that allows end users to understand the clinical coding rules and billing codes and therefore submit accurate claims and for the insurance company (also an end user) to efficiently monitor and maintain their clinical edit structure.

### BRIEF DESCRIPTION OF THE DRAWINGS

The preferred and alternative embodiments of the present invention are described in detail below with reference to the following drawings.

FIG. 1 is a block diagram of an exemplary system where the present invention is used;

FIG. 2 is a sample page extracted from the total displayable grid of clinical coding edits which establish the relationship of component CPT codes to the primary comprehensive or a mutually exclusive CPT code as based on the works denoted on Page 3/line 28-32;

FIGS. 3-5 are flow diagrams illustrating claim entry, CPT code adjudication by the edit process denoted, and processing, as occurs resultant to medical billing through CPT coding for clinical services provided; and.

FIGS. 6-13 illustrate screen shots of the clinical code edit management tool.

### DETAILED DESCRIPTION OF THE PREFERRED EMBODIMENT

The present invention provides a claims CPT code editing logic and a data management graphical user interface tool that allows a healthcare program administrator to easily manage and maintain a health care claims CPT code editing process. It also allows an end user or health care provider access to view and review the claims code editing process. Thus, while the invention is capable of processing claims without revealing the code editing logic being used, it is also flexible and powerful enough to make the code editing logic available or fully and constantly transparent to providers, and in the preferred embodiment, it operates in this transparent mode.

Transparency of this kind has not been utilized by prior claims processing systems in part due to a fear of increased risk of fraud. Specifically, an apparently implied premise exhibited by prior claims processing systems is that if the complete details of the code editing logic were disclosed to providers in advance of their submitting claims, providers might be more able and more tempted to manipulate the claims process to obtain illegitimately increased reimbursement. This fear has helped to foster the ubiquity of “black-box” claims processing systems. The preferred embodiment of the present invention departs from the industry and prior art by taking a different philosophical approach. Instead of obscuring the precise basis for the handling of the claim up front, the preferred embodiment makes the basis (not merely the medical and reimbursement policy, but also the complete details of the code editing logic) fully transparent and accessible to providers. Then, fraud is dealt with later, after the claim is submitted. While post claim submission fraud detection systems exist, they have hitherto been utilized only in conjunction with claims processing systems that are either not fully computerized or not fully transparent to providers as to the code editing logic prior to submission of the claim.

An additional advantage of transparency of code editing logic is that it empowers providers to actually assist the insurer in detecting errors in the logic. For example, if there is an outright error in a logic rule established by the insurer, and perhaps published on the insurer website, a provider may well detect the error, inform the insurer, and the logic can be corrected before the claim is submitted. This is advantageous to both provider and insurer. In contrast, in prior art “black-box” claims processing systems, a claim might be rejected inappropriately because of the error, but all the provider would know in the first instance was the rejection, or underpayment, and wasteful, inefficient (and typically acrimonious and duplicative) research would be required to get to the real source of the problem. Thus, the preferred embodiment transparent mode of the present invention makes the entire health insurance claims process more efficient.

Another efficiency resulting from the transparent mode of the preferred embodiment is that it eliminates the need for providers to purchase sophisticated and expensive software designed to try to reverse-engineer the code editing logic employed by the insurers. Specifically, for example, in various ways certain of such products use artificial intelligence and statistical analysis to evaluate claim rejections and reductions in an effort to “de-crypt” the underlying code editing logic that is being employed to generate the rejections. This process is so inherently difficult that the software, even though it is not perfectly effective, is very expensive. Concomitantly, services and seminars have evolved to “train” providers how to submit claims in a manner to maximize reimbursement from the black-box systems. Some of these foregoing are legitimate, some are actually illegitimate and the target of investigation. Either way however, both are completely unnecessary when providers are submitting claims to insurers using the preferred transparent embodiment of the present invention.

These efficiencies are part of why the preferred embodiment is preferred. However, the invention can also be practiced or implemented in a non-transparent, traditional mode. The transparent mode of the preferred embodiment can be implemented in several ways, such as, for example only, publishing the details of the code editing logic on a website accessible to providers, emailing them to providers, burning them onto a CD or any other media and sending the same to providers on request or periodically.

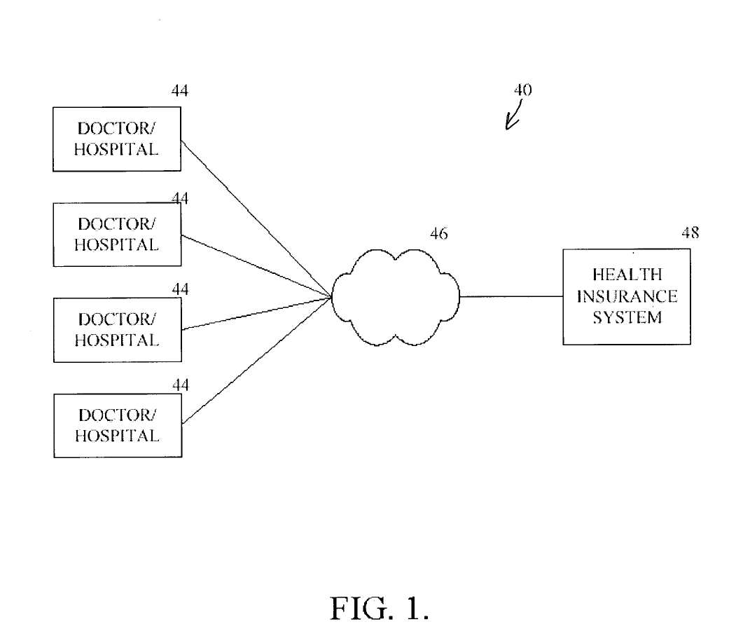

FIG. 1 illustrates an exemplary system 40 that implements the claims CPT code editing logic and the management tool. The system 40 includes a plurality of end user systems 44 (doctors/hospitals, or other health care providers) that are coupled to a health insurance system 48 over a public or private data network 46. The health insurance system 48 processes claims submitted by the end users at system 44, submitted or entered into the global health insurance system 48 via the network 46 or as claims submitted by hard copies delivered from an end user at the system 44 to the global health insurance system 48. The processing of health care claims is based on reimbursement charts that identify how much money is to be paid out for each action of a claim. The reimbursement procedures are further defined by rules that govern the relationship of the provider submitted CPT codes to each other. The developed CPT code editing logic allows a claims payment system 40 to determine from a series of codes submitted which of those codes are comprehensive and which are components of a more comprehensive code. As such, the processing of a claim by way of the developed code editing logic can identify if a subprocedure is requesting reimbursement as both a stand-alone procedure as well as part of a global comprehensive procedure by the same provider on the same date of service; and if that more than one request for such reimbursement is legitimate.

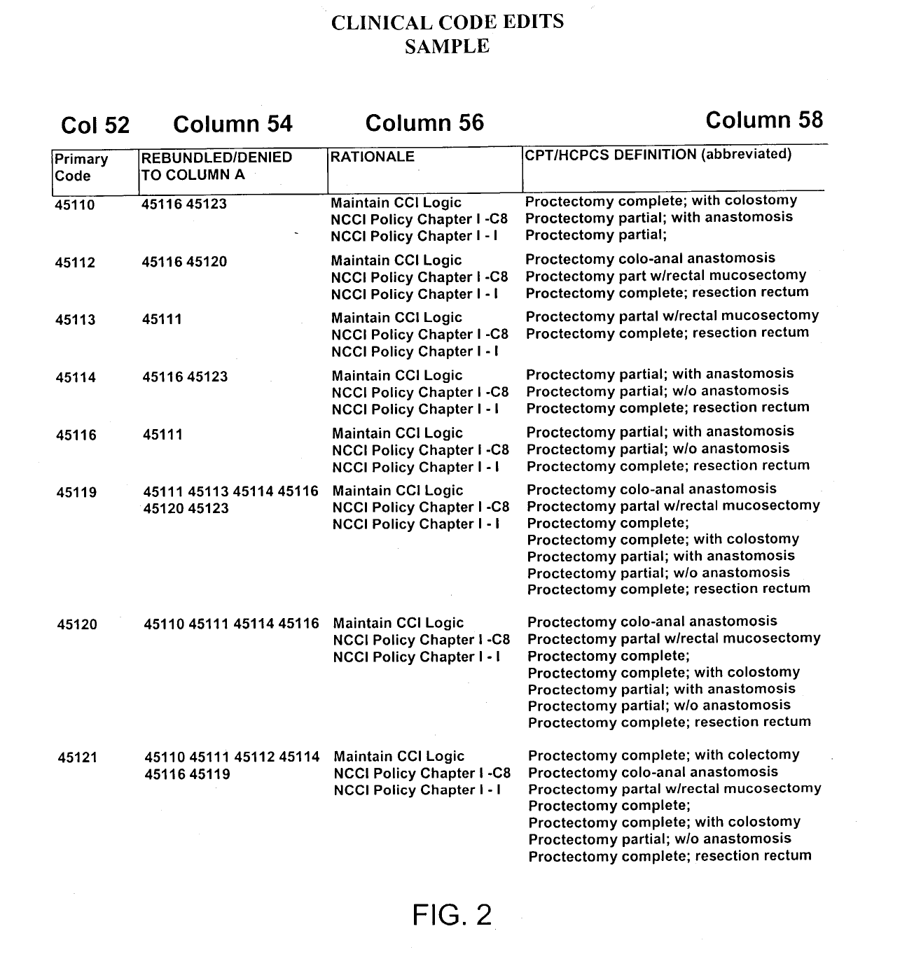

The health insurance system 48 also includes a code editing logic table that allows end users to view how claims are edited at any time. FIG. 2 illustrates an example of the developed CPT code editing logic which would be applied to provider submitted claims coding. Such logic would be available to providers in both electronic as well as print format. For example only, optionally and preferably, the logic underlying the handling of the claim could be published on an insurance company website fully accessible to providers. In this way, the basis for the handling of the claim (e.g., rejection, reduction, etc.) would not be a mystery or “black-box” from the providers' perspective. The page 50 presents procedure codes and the codes editing logic in table format. The page 50 includes a primary or comprehensive code column 52, a component or mutually exclusive code(s) of the primary code column 54, a rationale column 56, and a definition column 58. The primary code column 52 identifies a primary or comprehensive code number. The component or mutually exclusive code(s) column 54 indicates those stand-alone codes (codes which define a singular service, possible on its own merit) which are either already considered included in the primary comprehensive code or are considered mutually exclusive of same.

| Col.52 | Column 54 | Column 56 | Column 58 |
|---|---|---|---|
| 45119 | 45111 45113 45114 | Maintain CCI Logic | Proctectomy colo-anal anastomosis |
| | 45116 45120 45123 | NCCI Policy Chapter I-C8 | Proctectomy partial w/rectal mucosectomy |
| | | NCCI Policy Chapter I-I | Proctectomy complete; |
| | | | Proctectomy complete; with colostomy |
| | | | Proctectomy partial; with anastomosis |
| | | | Proctectomy partial; w/o anastomosis |
| | | | Proctectomy complete; resection rectum |

In other words, if the identified primary code 45119 (“Protectomy, combined abdominoperineal pull-through procedure—e.g. colo-anal anastomosis—with creation of colonic reservoir—e.g. J-Pouch—with or without proximal diverting colostomy”) and 45111 (“Partial resection of rectum, transabdominal approach”) are both claimed by an end user, 45111 will not be reimbursed because 45111 is included as part of 45119. That is, “proctectomy” (the total removal of the rectum) would by definition include the “partial resection of rectum”. In addition, the surgical approach in 45119 is described as “abdominoperineal” (both transabdominal—through the abdomen—as well as perineal—between the buttocks externally, whereas 45111 is a transabdominal approach only. Similarly, 45119 includes as a comprehensive code those parts of the procedure described individually by 45113, 45114, 45116, 45120, and 45123.). The rationale column 56 identifies the general code editing rule that identifies the relationship of columns 52 and 54. By allowing the end users to view how claims coding is thus adjudicated, the end users can be more efficient in the coding of the procedures they accomplish, can avoid making errors when drafting a medical claim, and can determine if the code editing logic is not adequately appreciating the medical procedures performed. In turn this would allow the end users to intelligently discuss the code editing logic employed with the health insurance company associated with the health insurance system 48.

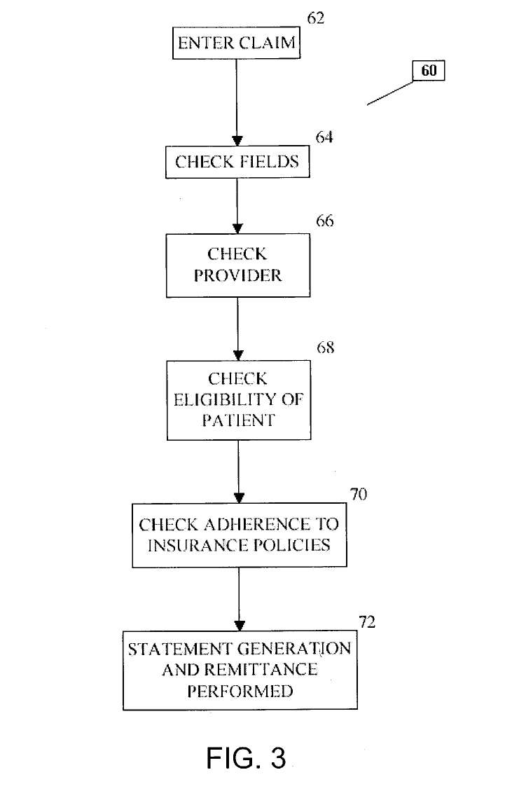

FIG. 3 presents a flow diagram that illustrates a claim processing process 60. First, at block 62, a claim is entered into a claims processing application program executed by the health insurance system 48. The claim is entered by health insurance system 48 personnel or over the network 46 by an operator at the end user system 44. Next, at block 64, all fields included in the entry of a claim are manually or automatically checked for proper completion. Then, at block 66, the health care provider associated with the claim is checked to determine if they are an approved health care provider for the insurance company. At block 68, the health insurance system 48 checks if the patient associated with the claim is eligible for coverage by the insurance company. If the checks performed at blocks 64-68 show compliance, the health insurance system 48 processes the submitted claim medical/clinical billing codes according to predefined code editing logic see block 70.

The predefined code editing logic can be of any kind. That is, the invention is capable of processing claims on the basis of, or according to, any code editing logic, whether it is confidential and purely proprietary to the insurance company or a third party, or a publicly available code editing logic such as may be utilized by the government, or a customized combination of the two, or any mixture of the foregoing. However, even though the invention is flexible and powerful enough to utilize any code editing logic, in the preferred embodiment, the invention utilizes to the maximum possible extent internationally recognized and publicly-available resources. Thus, the claims processing system and associated code editing logic preferably include or utilize Current Procedural Terminology (CPT™) developed by the American Medical Association (AMA), Correct Coding Initiative (CCI) developed by Centers for Medicare and Medicaid Services (formerly HCFA), other nationally or internationally recognized and publicly-available resources (e.g. CPT Assistant from the AMA, Medicode's Coders Desk Reference Manual and Coders Desk Reference for Pathology and Laboratory, in addition to edits performed by the operator of the health insurance system 48.

Some advantages of utilizing such publicly available code editing logic is that the resultant system is more nationally uniform, more transparent, based on a broader social consensus, and thus typically less subject to private partisan controversy than a purely proprietary logic. However, despite these and other advantages, they have not been fully utilizable or utilized by prior computerized health insurance claims processing systems for at least three reasons. First, the publicly available code editing logic has hitherto not been considered sufficiently comprehensive to provide the basis for a complete claims processing system. Second, the publicly available code editing logic has hitherto not been available in a comprehensive form that is amenable to ready or efficient utilization by a computerized claims processing system. For example, the Federal Registry has many rules that are written only, and not pre-encoded into code logic amenable to computer processing. Third, utilization of publicly available code editing logic in a claims processing system apparently has been perceived as contrary to the private commercial interests of the companies that make and sell systems that utilize purely proprietary and secret “black box” code editing logic. The preferred embodiment of applicant's invention described herein overcomes each of these three problems. First, the preferred embodiment is powerful and intelligent enough to effectively utilize the publicly available code editing logic despite its incompleteness. Second, the preferred embodiment compensates for the un-encoded form in which portions of the publicly available rules are made available. Third, the applicant, as an insurance company, is not locked into a framework of commercial interests and incentives that have hitherto precluded deployment of a transparent (or non “black box”) claims processing system as disclosed herein.

At the claim processing step in block 70, the health insurance system 48 determines if any claims have been made for procedures that are actually a part of another that is claimed, or are considered incidental to another procedure that is also claimed. Rejection of any such procedures then occurs and, at block 72, the claim is priced, remaining Clinical Edit rules applied, and remittance of the claim occurs along with the generation of a statement. The statement indicates what if any procedures were rejected and why they were rejected (i.e., what code editing rule applies).

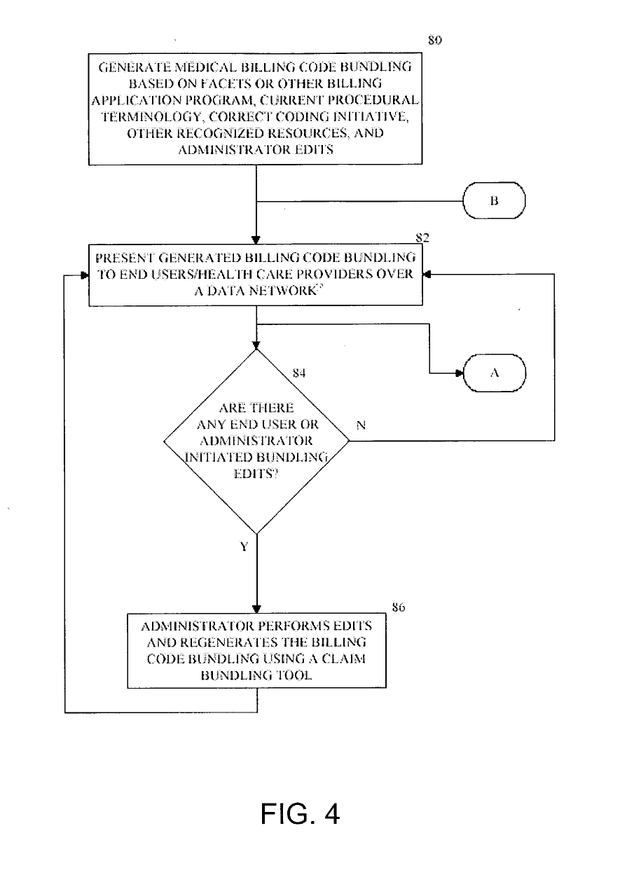

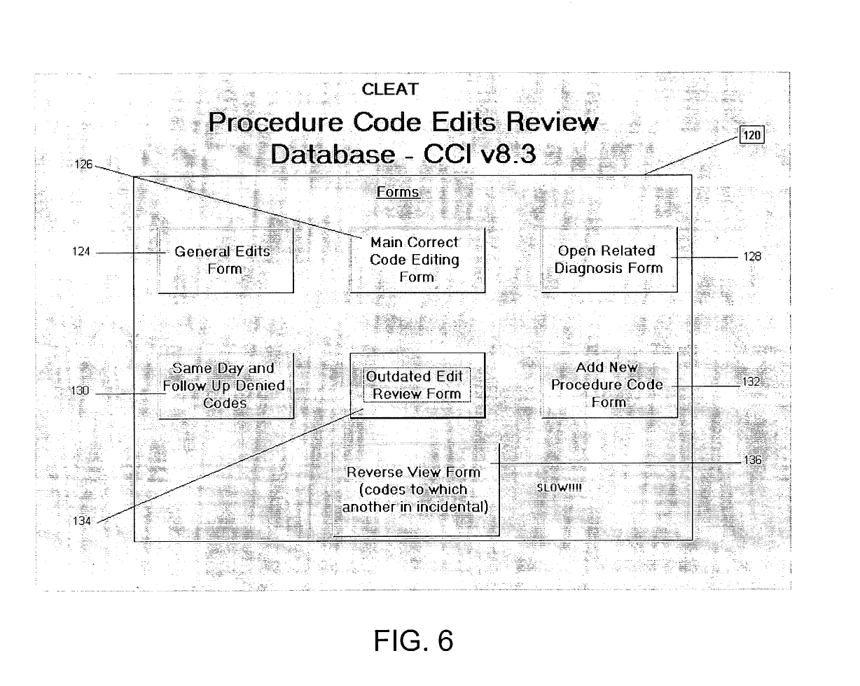

FIG. 4 illustrates an exemplary process that is performed concurrently with the process 60 of FIG. 3 and that is performed by the system 40 as shown in FIG. 1. First, at block 80, the operator or administrator of a health insurance policy executed by the health insurance system 48 generates a medical/clinical billing code editing process based on CPT, CCI, other nationally and internationally recognized resources, or administrator edits. Next, at block 82, at least part of the generated medical/clinical billing code editing process is made available for presentation to the end users systems 44 over the network 46. Then, at decision block 84, if there exists any end user or health care system administrator initiated edits of the medical/clinical billing code editing process, the administrator performs any such approved edits, see block 86. An exemplary medical/clinical code editing application program is shown by example in the screen shots below in FIGS. 6-13. After any additional edits are so performed on the submitted billing codes or if there were no edits required, the process returns to block 82.

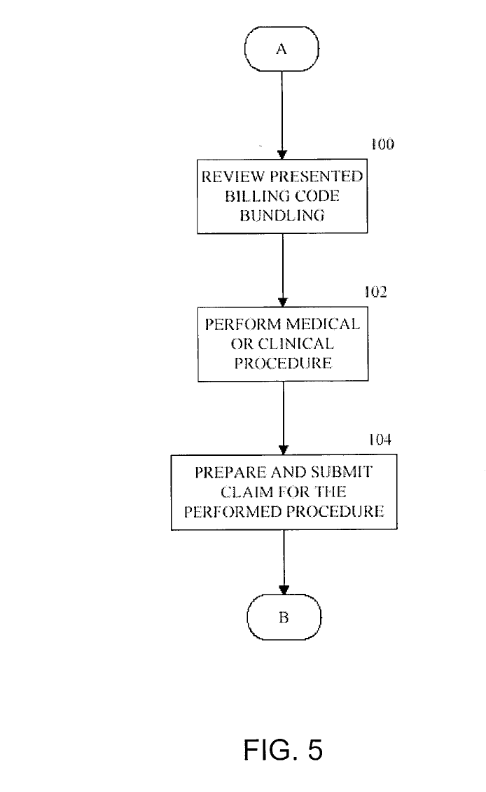

FIG. 5 illustrates an exemplary process performed by the end user, after the presentation and review of the generated medical/clinical billing code editing process at block 82 of FIG. 4 is made available to them. First, at block 100, the end user reviews presented billing code edits based on medical procedures they are about to perform or medical procedures they have already performed for which they are preparing claims. At block 102, the end user 44 performs the medical procedures and produces translation of those procedures to one or more clinical codes, based on the review of the presented medical/clinical billing code edits. At block 104, the end user submits claims by utilizing medical/clinical billing codes for the performed medical procedures. It can be appreciated that the review of the presented medical/clinical billing code edits need not necessarily be done before every medical procedure or at the time of a claim submission. But, the user saves time and effort following the performance of medical procedures when generating claims for same after some review of the medical/clinical billing code edits. A knowledge of the various aspects of the medical/clinical billing code edits thus gained improves coding accuracy thus improving the timeliness of reimbursement by the insurance processor of the submitted claim. The processes performed in FIGS. 4 and 5 can be performed in various order without departing from the scope of the present invention. For example, review of medical/clinical billing code edits (block 100) can occur after preparation and submission of a claim (block 104).

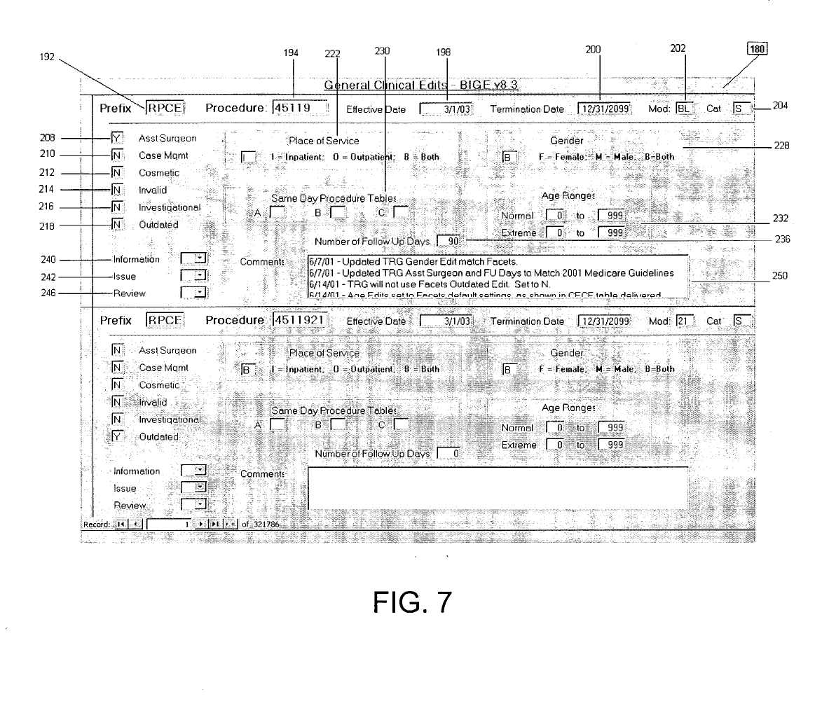

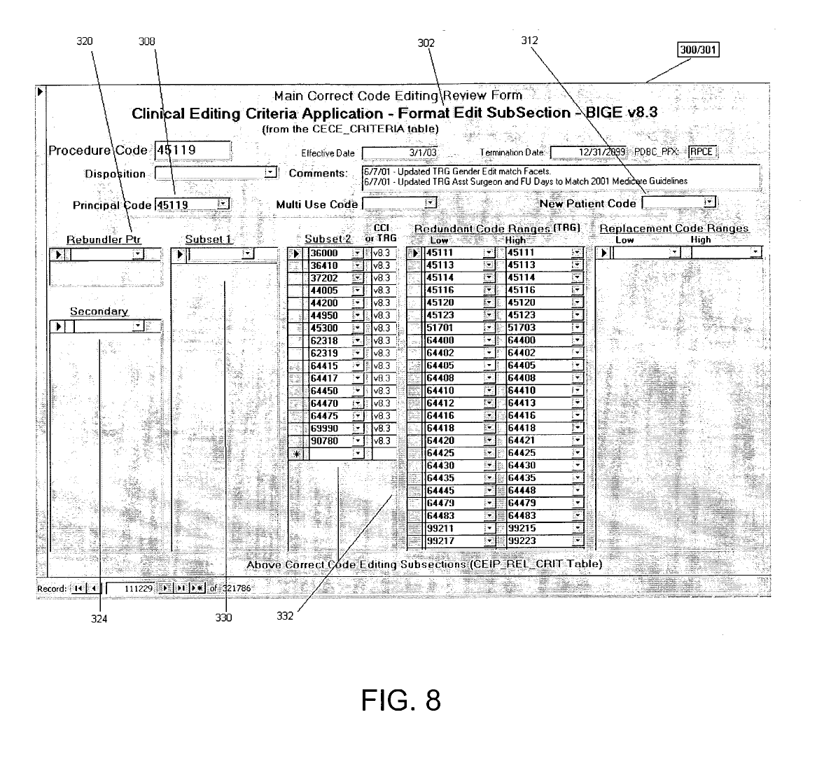

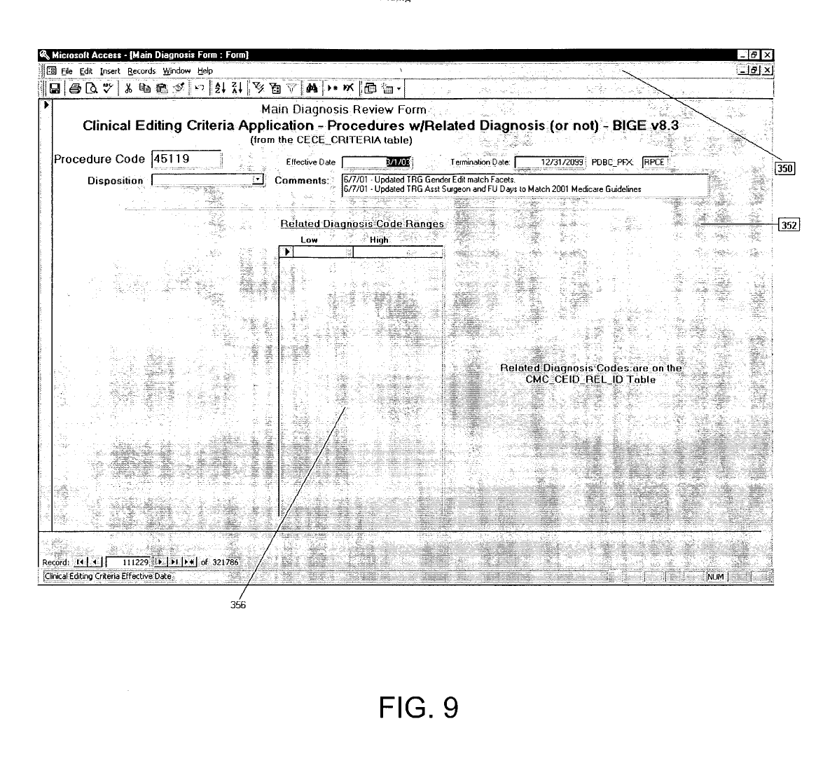

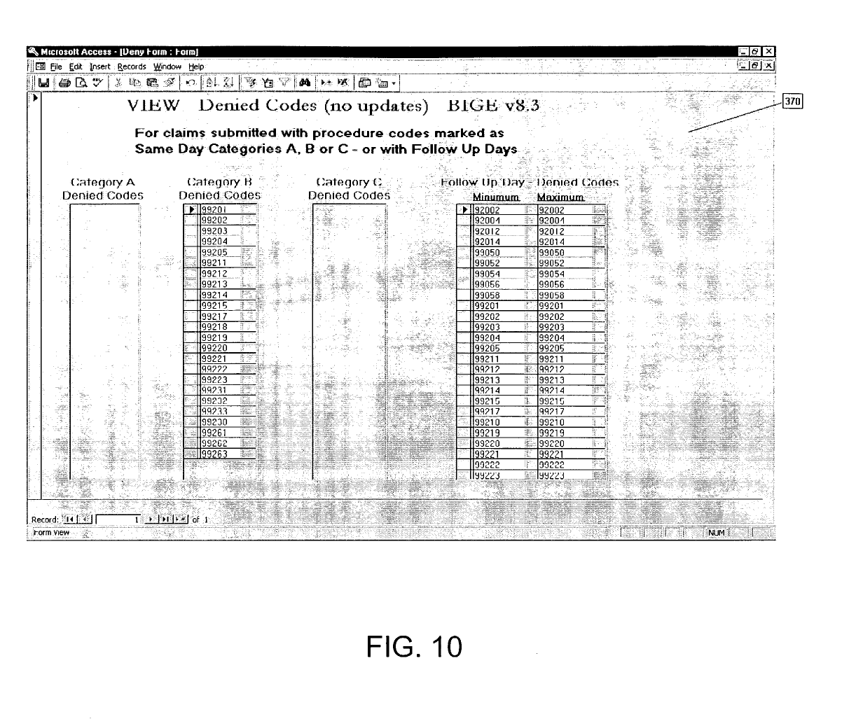

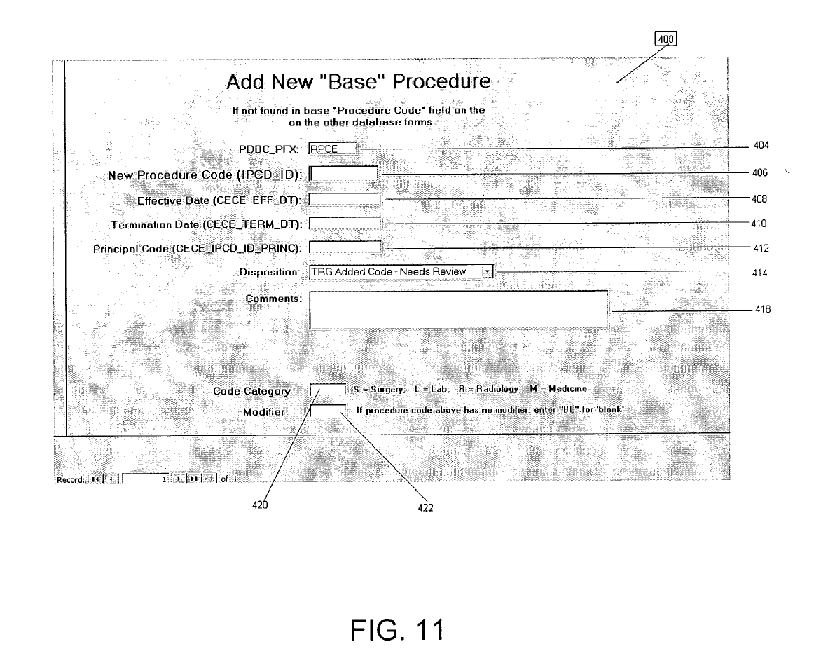

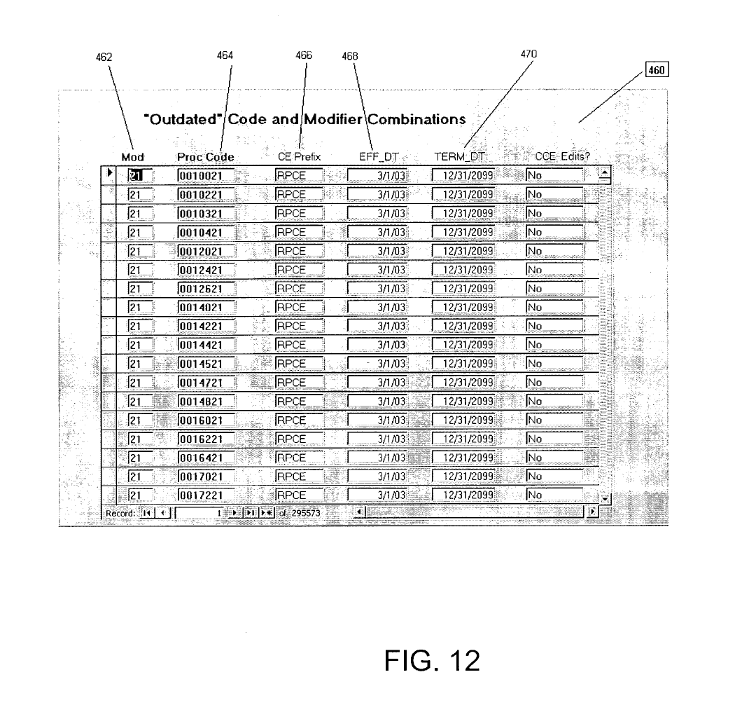

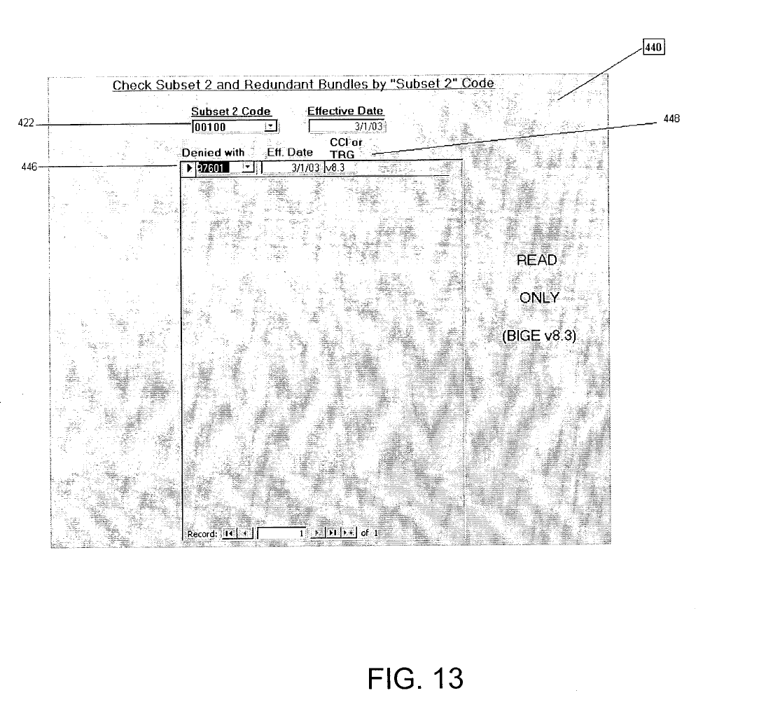

FIGS. 6-13 are screen shots of an exemplary CODE EDITING TOOL for use by the administrator of a health care program at the health insurance system 48. FIG. 6 is a screen shot of a forms page 120 that includes a plurality of selectable user interface buttons for accessing various forms for managing a claims code editing procedure. The buttons include a General Edits Form button 124, a Main Correct Code Edit Form (Main CCE Form) button 126, an Open Related Diagnosis Form button 128, a Same Day and Follow Up Denied Codes button 130, an Add New Procedure Code Form button 132, an Outdated Edit Review Form button 134, and Reverse View Form (Reverse CCE Rules) button 136. When the administrator selects the General Edits Form button 124 a general edits form is presented, see the example in FIG. 7. After administrator selection of the Main Correct Code Edit Form button 126 a main clinical code edit form is presented as shown by example below in FIG. 8. Administrator selection of the Open Related Diagnosis Form button 128 presents a main diagnosis review form shown by example in FIG. 9. Administrator selection of the Same Day and Follow Up Denied Codes button 130 presents a denied codes view window as shown by example below in FIG. 10. Administrator selection of the Add New Procedure Code Form button 132 presents an add new procedure code form as shown by example below in FIG. 11. Administrator selection of the Outdated Edit Review form button 134 presents an outdated code and modifier combination form as shown by example below in FIG. 12. Administrator selection of the Reverse View Form button 136 presents a check edits page as shown by example below in FIG. 13.

FIG. 7 illustrates a screen shot of an exemplary General Edits Form 180 presented in a window generated by a database application program, such as ACCESS®. The window 180 includes a scrollable work area that presents various editable descriptive features for a medical/clinical procedure and that allows for searching of the various fields. The following is a description of example fields included in a medical/clinical procedure as displayed in the work area. Each medical/clinical procedure includes a prefix field 192. The prefix included within the prefix field 192 identifies the procedure into a general category. A procedure field 194 presents the identifier for the clinical procedure. Date fields 198 and 200 present an effective date and a termination date, respectively, for the associated procedure. The termination date is the date that the edit is no longer effective. The mod field 202 presents a further identifier for the associated procedure. A cat (category) field 204 presents the category that the associated procedure belongs to. The categories include the following: S(Surgery); L(Lab); R(Radiology); and M(Medicine). An asst (assistant) surgeon field 208 presents a yes if the associated procedure will reimburse a claim for an assistant surgeon, if one is included along with a claim for the procedure. A case mgmt (management) field 210 presents a case management review message if a Y(Yes) is inserted in the field 210. A cosmetic 212 indicates if a procedure warning message is to be presented if the associated procedure is cosmetic. An invalid field 214 indicates if the associated procedure is not reimbursed. An investigational field 216 indicates if the associated procedure is experimental. An outdated field 218 indicates if the associated procedures are outdated and inappropriate.

A place of service field 222 indicates the place where the procedure is allowed to take place. The choices for place of service are as follows: I=Inpatient; O=Outpatient; and B=Both. A gender field 228 indicates the gender for which the associated procedure is reimbursable. The choices are F=Female, M=Male, and B=Both. A same day procedure tables area 230 indicates what group (A, B, or C) of claims medical/clinical codes will not be reimbursed if performed on the same day of the associated procedure if the associated procedure includes an S(Surgery) cat code, see FIG. 10. Age ranges field 232 indicates the age ranges for which specific patient medical service codes will receive reimbursement. The number of follow up days field 236 indicates the number of days for which follow-up of the associated procedure by the person performing the procedure is expected, thus precluding further reimbursement of certain medical services as represented by specific clinical/medical codes, see FIG. 10.

An information field 240 identifies if there is any information associated with the clinical code representing the procedure performed. An issue field 242 indicates if there are issues associated with the clinical code representing the procedure performed. A review field 246 indicates if a review of the clinical code representing the procedure performed must occur. If any one of the fields 240-246 indicates that there are associated information, issues, or review, a claim processor will be alerted to any associated information, issues, or review when they are processing a claim that includes the associated procedure. Information, issue, or review messages are attached for viewing. Finally, a comments fields 250 allows the administrator to insert any pertinent information pertaining to the associated procedure.

FIG. 8 illustrates a Main Correct Code Edit Form window 300 that presents a main code editor review form 301 upon selection of the Main Correct Code Edit Form (Main CCE Form) button 126 as shown in FIG. 6. The main code editor review form 301 includes an information area 302 and an editor review area 320. The information area 302 includes some of the basic information included in the general clinical edits window 180, such as procedure code, effective date, termination date, and prefix comments. The information area 302 also includes a principal code field 308 that indicates a possible other procedure code to which this procedure code refers. A new patient code field 312 indicates if the associated procedure has a different reimbursement policy for a new patient claim.

The clinical code editor review area 320 includes a plurality of fields that indicate those procedure codes that are incidental to the primary comprehensive code, as well as other codes related in different ways to the primary comprehensive code. It can be appreciated that fields in area 320 can indicate various medical/clinical code relationships that are defined by various public and private clinical code editing rules and procedures. See items 324, 330, and 332 in FIG. 8 as examples of detail available.

FIG. 9 illustrates a Open Related Diagnosis form window 350 that presents a main diagnosis review form 352 upon selection of the Open Related Diagnosis Form button128 as shown in FIG. 6. The main diagnosis review form 352 presented in the window 350 includes a related diagnosis code ranges field 356 that indicates diagnosis codes that relate to the respective procedure code.

FIG. 10 illustrates codes that are denied on the same day or on a follow up day. The denied codes window 370 is activated upon selection of the Same Day and Follow Up Denied Codes button 130 as shown in FIG. 6. The denied codes window 370 presents codes that are denied based on same day categories A, B, and C. The denied codes window 370 also includes minimum and maximum range for follow up day denied codes that are denied if performed and claimed within the follow up period indicated field 236 from FIG. 7.

FIG. 11 illustrates an Add New Base Procedure page 400 that is presented upon selection of the Add New Procedure Code Form button 132. The add new base procedure page 400 includes a prefix field 404 for entering a prefix for a new base procedure. A new procedure code field 406 allows the administrator to enter a procedure code for the new base procedure. Effective and termination date fields 408 and 410 allow the administrator to enter corresponding dates. A principal code field 412 allows the administrator to enter a principal code. A disposition field 414 allows the administrator to enter a current status for the new procedure code entered above. A comments field 418 allows the administrator to enter comments for the new base procedure. A code category field 420 allows the administrator to identify the new base procedure as one of a S=Surgery; L=Lab, R=Radiology, or M=Medicine cat. Finally, the new base procedure page 400 includes a modifier field 422 which allows the administrator to add a code modifier that will be presented in the mod field 202 as shown in FIG. 7.

As shown in FIG. 12, a page 460 is presented upon selection of the Outdated Edit Review Form button 134. The procedure code field 464 lists a series of clinical procedure codes (along with the appropriate clinical edit prefix in the CE Prefix field 466) which alone or with a code modifier in the Mod 462 field are considered no longer valid. The effective date as indicated in the EFF DT field 468 and the termination date as indicated in the TERM DT 470 are given for each clinical code/code with modifier.

As shown in FIG. 13, a page 440 is presented upon selection of the Reverse View Form button 136. It presents a check edits page as shown whereupon a clinical code can be entered as a subset 2 (component) code in field 422 to find if it would be denied with a comprehensive code(s) in field 446 with further notation of whether this relationship is set by CCI or TRG (The Regence Group) in field 448.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A health insurance claim entering method comprising:
generating plurality of health care procedure clinical code editing rules at a health insurance company;
presenting at least a portion of the generated plurality of clinical code editing rules to a health care provider;
reviewing at least a portion of the presented plurality of clinical code editing rules; and
entering a claim for one or more performed health care procedures.

2. The method of claim 1, further comprising:
sending the entered claim to the health insurance company;
processing the sent claim according to the health care procedure clinical code editing rules; and
generating remittance based on the processed claim.

3. The method of claim 2, wherein the clinical code editing rules are based on Current Procedural Terminology (CPT), Health Care Procedure Coding System (HCPCS), and Correct Coding Initiative (CCI) rules and logic.

4. The method of claim 3, wherein the clinical code editing rules are further based on edits performed by an operator using a graphical user interface tool on a computer system associated with the health insurance company.

5. The method of claim 3, wherein the clinical code editing rules are further based on CPT Assistant from the American Medical Association, and Medicode's Coders Desk Reference Manual and Coders Desk Reference for Pathology and Laboratory.

6. The method of claim 1, further comprising sending at least a portion of the generated plurality of clinical code editing rules from a computer system associated with the health insurance company over a data network to a computer system associated with the health care provider.

7. A health insurance claim system comprising:
a health insurance company comprising:
a computer system with a graphical user interface tool for generating a plurality of health care procedure clinical code editing rules; and
a component for sending at least a portion of the generated plurality of health care procedure clinical code editing rules to a recipient over a data network; and
at least one health care provider comprising:
a computer system coupled to the data network for receiving the sent plurality of health care procedure clinical code editing rules and for presenting the received plurality of clinical code editing rules for review; and
a means for entering a claim for one or more performed health care procedures.

8. The system of claim 7, wherein the health care provider further comprises a component for sending the entered claim to the health insurance company, the health insurance company processes the sent claim according to the health care procedure clinical code editing rules, and generates remittance based on the processed claim.

9. The system of claim 7, wherein the clinical code editing rules are based on Current Procedural Terminology (CPT), Health Care Procedure Coding System (HCPCS), and Correct Coding Initiative (CCI).

10. The system of claim 9, wherein the computer system of the health insurance company further comprises a graphical user interface tool for editing the clinical code editing rules

11. The system of claim 9, wherein the clinical code editing rules are further based on CPT Assistant from the American Medical Association, and Medicode's Coders Desk Reference Manual and Coders Desk Reference for Pathology and Laboratory.

12. A computer generated graphical user interface (gui) generated by a data base program (ACCESS®) for managing clinical edit data and clinical code editing rules for medical procedures of a medical claims processing applications program, the gui comprising:
a presentation component configured to present at least a portion of the medical procedures and associated clinical edit data; and
a clinical code editing rules presentation component configured to present the clinical code editing rules associated with the medical procedures.

13. The gui of claim 12, further comprising a clinical edit data editing component configured to allow editing of the technical edit data.

14. The gui of claim 13, further comprising a clinical code editing rules editing component configured to allow editing of at least one of the clinical code editing rules.

15. The gui of claim 13, wherein the clinical edit data includes category information, service location information, age and gender related information, and follow up days information.

16. The gui of claim 15, wherein the clinical edit data further includes same day procedure information.

17. The gui of claim 16, wherein the clinical edit data further includes effective date and termination date.

18. The gui of claim 14, wherein the clinical code editing rules presentation component includes a subcomponent configured to present reverse clinical code editing rules.

19. The gui of claim 18, further comprising a clinical edit data editing component configured to allow entry of a new procedure with associated clinical edit data.

20. The gui of claim 12, wherein the presentation component includes a scrolling device for scrolling through the presented medical procedures.

21. The gui of claim 20, wherein the presentation component further includes a filtering component for filtering the medical procedures based on a selection of clinical edit data and presenting the filtered medical procedures.

22. A method of processing health insurance claims comprising:
disclosing code editing logic rules to a health care provider, and
reimbursing claims submitted by the health care provider in accordance with the disclosed code editing logic rules.

23. The method of claim 22 wherein the code editing logic rules are derived in part from publicly available code sources.

24. A method of processing health insurance claims comprising:
deriving code editing logic rules in part from publicly available code sources, and
reimbursing claims submitted by a health care provider in accordance with the code editing logic rules so derived.

25. The method of claim 24 wherein the code editing logic rules are disclosed to a health care provider.
